(19) United States
(12) Patent Application Publication
(10) Pub. No.: US 2016/0365879 A1
(43) Pub. Date: Dec. 15, 2016

(54) RF RESOURCE UTILIZATION OF MULTI RADIO SYSTEM THROUGH A CORE-RESOURCE RFIC

(71) Applicant: QUALCOMM Incorporated, San Diego, CA (US)

(72) Inventors: Samir Salib Soliman, Poway, CA (US); Won-ick Lee, San Diego, CA (US); Bongyong Song, San Diego, CA (US); Olufunmilola Awoniyi-Oteri, San Diego, CA (US)

(21) Appl. No.: 14/735,883

(22) Filed: Jun. 10, 2015

(51) Int. Cl. H04B 1/00

(52) U.S. Cl. CPC H04B 1/0053; H04W 88/06

(57) ABSTRACT

A method for wireless communication is described. A primary radio frequency integrated circuit (RFIC) supporting a plurality of radio frequency (RF) receive paths is provided. Standalone RF resources of a core-resource RFIC to integrate with the plurality of RF receive paths of the primary RFIC to enable an additional functionality of the primary RFIC are then added. A minimum set of RF resources necessary to add support for an additional RF receive path may be determined, and RF resources, including one or more of an antenna, an RF front end, and a low-noise amplifier (LNA) and switches of the primary RFIC, may be shared. A digital baseband integrated circuit (IC), i.e. a modem, may be operated to support both a first of the plurality of RF receive paths from the primary RFIC and a second of the plurality of RF receive paths from the core-resource RFIC.

### BACKGROUND

Field of the Disclosure

The present disclosure, for example, relates to wireless communication systems, and more particularly to efficiently adding functionality to a primary radio frequency integrated circuit (RFIC) by adding a core-resource RFIC to integrate with existing radio frequency (RF) resources of the primary RFIC.

Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, space and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple wireless devices. Base stations may communicate with wireless devices on downstream and upstream links. Each base station has a coverage range, which may be referred to as the coverage area of the cell.

Wireless devices, including mobile devices (e.g., user equipments (UEs)) and access points (e.g., a small cell for an eNodeB (eNB) such as a pico eNB, a femto eNB or a home eNB) that access such wireless communications systems increasingly use greater numbers of downlink radios and RF resources, but such RF resources are limited by form factor and cost. Examples of wireless device configurations using multiple downlink radios include downlink carrier aggregation for LTE, LTE-Advanced (LTE-A), and, for wireless device two or more subscriber identity modules (SIMs), a dual radio dual-SIM dual standby (DR-DSDS) configuration, including LTE for unlicensed spectrum (LTE-U) and licensed-assisted access for LTE (LTE-LAA). Such RF resources include antennas, an RF front end, an RF integrated circuit (RFIC), and a modem. The RF front end may include switches and RF filters. The RFIC may include low noise amplifiers (LNAs), synthesizers (mixers), and certain base band (BB) processing resources formed on the RFIC. The BB processing resources may include analog to digital converters (ADCs), BB filters, and a processing engine. The modem may also be used for BB processing.

In order to support different downlink radios, a single RF chain beginning from an antenna of a mobile device may include multiple RF paths having multiple RF resources, e.g. multiple LNAs, multiple synthesizers, etc. While a particular RF radio requiring a particular RF path is in use, redundant RF resources on different paths of the RF chain of the RFIC may not be used. For example, a first primary data receive (1PRx) path of a PRx chain may be used at a given time for a single RF radio. However, the PRx chain may have many RF paths, including, for example, 8 PRx paths total, portions of some of which may not be used when 1PRx is in use, representing unused RF resources during that time.

### SUMMARY

A main (or primary) RFIC may be used in a wireless device, including mobile devices (e.g., a user equipment (UE)) and access points (e.g., a small cell for an eNodeB (eNB) such as a pico eNB, a femto eNB or a home eNB) supporting multiple downlink radios. The primary RFIC may support an RF chain having multiple RF paths to support the multiple downlink radios. While a first RF path is in use, RF resources of unused RF paths that are not shared with the first RF path may go unused. The portions of the RF paths that are not shared with the first RF path while in use may represent unused RF resources during that time.

An additional, core-resource RFIC may provide standalone RF resources for the RF paths that are not being used in the primary RFIC to enable additional functionality. These standalone RF resources represent those RF resources that are not shareable between multiple RF paths in the primary RFIC, and are not present in the primary RFIC as redundant RF resources. The shared RF resources may include the interface with the RF front end, switches, an inter-RFIC interface, and certain LNAs (as well as the antenna and RF front end that may be shared, but external to the primary RFIC). The standalone RF resources may include synthesizers (mixers) and certain base band resources, including analog to digital converters (ADCs), BB filters, and processing engines, that are not shareable by a second RF path while in use by a first RF path. In some cases, an LNA may be shared between two RF paths if the bandwidth of the LNA supports both RF paths. But in certain other cases different LNAs in the primary RFIC are used for two RF paths.

In one illustrative embodiment, a method for wireless communication is disclosed. The method may include providing a primary RFIC supporting a plurality of RF receive paths, and adding standalone RF resources of a core-resource RFIC to integrate with the plurality of RF receive paths of the primary RFIC to enable an additional functionality of the primary RFIC.

In a second illustrative embodiment, an apparatus for wireless communication is disclosed. The apparatus may include a primary RFIC supporting a plurality of RF receive paths. The apparatus may also include means for adding standalone RF resources of a core-resource RFIC to integrate with the plurality of RF receive paths of the primary RFIC to enable an additional functionality of the primary RFIC.

In a third illustrative embodiment, an apparatus for wireless communication is disclosed. The apparatus may include a primary RFIC supporting a plurality of RF receive paths, and a core-resource RFIC comprising standalone RF resources to integrate with the plurality of RF receive paths of the primary RFIC to enable an additional functionality of the primary RFIC.

In a fourth illustrative embodiment, a non-transitory computer-readable medium storing computer-executable code for wireless communication is disclosed. The code may be executable by a processor to add RF resources of a core-resource RFIC to integrate with a plurality of RF receive paths of a primary RFIC to enable an additional functionality of the primary RFIC.

Aspects of the various illustrative embodiments may include determining a minimum set of RF resources necessary to add support for an additional RF receive path. The additional functionality may include support for an additional number of downlink radios to operate concurrently. In some aspects, the various illustrative embodiments may include sharing RF resources of the primary RFIC between a first portion of a first of the plurality of RF receive paths supported by the primary RFIC and a first portion of a second of the plurality of RF receive paths supported by the primary RFIC and the core-resource RFIC. The embodiments may also include operating a digital baseband integrated circuit (IC) to support both a first of the plurality of RF receive paths from the primary RFIC and a second of the plurality of RF receive paths from the core-resource RFIC.

In some aspects, the added standalone RF resources of the core-resource RFIC include at least a mixer. The added standalone RF resources of the core-resource RFIC include at least a base band filter. The primary RFIC may include at least a first mixer and a first base-band filter for a first of the plurality of RF receive paths of the primary RFIC, and the standalone RF resources may include at least a second mixer and a second base-band filter for a second of the plurality of RF receive paths from the primary RFIC. The core-resource RFIC may include an RF interface to receive RF signals from the primary RFIC.

In some aspects, the embodiments may include using a low-noise amplifier of the primary RFIC for a first RF receive path of the plurality of RF receive paths, and using the standalone RF resources of the core-resource RFIC for the first RF receive path from the primary RFIC. In some aspects, the embodiments may include sharing a low-noise amplifier of the primary RFIC between both a first RF receive path of the plurality of RF receive paths and a second RF receive path of the plurality of RF receive paths. In some aspects, the embodiments may further include sharing an antenna and a RF front end between a first RF path of the plurality of RF receive paths of the primary RFIC and a second RF path of the plurality of RF receive paths that uses the standalone RF resources of the core-resource RFIC.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system, in accordance with various aspects of the present disclosure;

FIG. 2 illustrates a system diagram that shows an example of a wireless communications system, in accordance with various aspects of the present disclosure;

FIG. 3 shows a block diagram of an apparatus for use in a wireless device for wireless communication, in accordance with various aspects of the present disclosure;

FIG. 4 shows a block diagram of a receiver apparatus for use in a wireless device for wireless communication, in accordance with various aspects of the present disclosure;

FIG. 5 shows a block diagram of the receiver apparatus for use in a wireless device for wireless communication, annotated to illustrate two RF receive paths, in accordance with various aspects of the present disclosure;

FIG. 6 shows a second block diagram of the receiver apparatus for use in a wireless device for wireless communication, annotated to illustrate two RF receive paths, in accordance with various aspects of the present disclosure;

FIG. 7 shows a block diagram of a wireless device for use in wireless communication, in accordance with various aspects of the present disclosure;

FIG. 8 shows a block diagram of a base station (e.g., an access point or a base station forming part or all of an eNB) for use in wireless communication, in accordance with various aspects of the present disclosure;

FIG. 9 is a flow chart illustrating an example of a first method for wireless communication, in accordance with various aspects of the present disclosure; and

FIG. 10 is a flow chart illustrating an example of a second method for wireless communication, in accordance with various aspects of the present disclosure.

### DETAILED DESCRIPTION

In order to support multiple downlink radios in a mobile device, a single radio frequency (RF) chain beginning from an antenna of a mobile device may include multiple RF paths, each RF path having multiple RF resources contained within an RF integrated circuit (RFIC). While a particular RF radio requiring a particular RF path is in use, redundant RF resources on different paths of the RF chain of the RFIC are not used. The RF resources of the RFIC that are not used by the particular RF path in use represent unused RF resources during that time. Similarly, a modem may be configured to provide processing resources for the different RF paths, yet only a portion of the modem related to the particular RF path may be in use at a given time when the particular RF path is in use.

Furthermore, simply adding RF resources to the same RFIC to support the functionality of multiple RF paths may be problematic. Placing multiple synthesizers (mixers) in a single RFIC to support additional RF paths may be problematic because of mutual interference between the already-existing mixers and the mixers that would be added, as well as the difficulty and the high cost of designing such configurations. At the same time, however, adding a second, duplicate RFIC may not be economical, and represent still further unused RF resources.

A main (or primary) RFIC may be used in a wireless device, including mobile devices (e.g., a user equipment (UE)) and access points (e.g., an access point or a small cell base station or eNB) supporting multiple downlink radios. The primary RFIC may support an RF chain having multiple RF paths to support the multiple downlink radios. For example, the primary RFIC may be one of several existing RFICs that provide support for a single radio, but has multiple RF paths to support a number of different frequency bands. An additional, core-resource RFIC can provide standalone RF resources for the RF paths that are not being used in the primary RFIC to enable additional functionality. These standalone RF resources represent those RF resources that are not shareable between multiple RF paths in the primary RFIC, and are not present in the primary RFIC as redundant RF resources.

The shared RF resources may include the interface with the RF front end, switches, an inter-RFIC interface, and certain LNAs (as well as the antenna and RF front end that may be shared, but external to the primary RFIC). The standalone RF resources include synthesizers (mixers) and certain base band resources, including analog to digital converters (ADCs), BB filters, and processing engines, that are not shareable by a second RF path while in use by a first RF path. In some cases, an LNA can be shared between two RF paths if the bandwidth of the LNA supports both RF paths. But in certain other cases different LNAs in the primary RFIC are used for two RF paths. In other cases an additional external LNA is used.

The core-resource RFIC may use a pre-existing inter-RFIC interface provided by the primary RFIC to access RF resources at a point in an RF path. For example, the inter-RFIC interface may provide access to an RF path between the LNAs and a synthesizer (mixer) of the primary RFIC. Because the primary RFIC and its interface may be pre-existing, the core-resource RFIC presents an efficient and economical way to provide RF resources to support additional RF paths. Though discussed above in terms of a single receive chain, the core-resource RFIC may also have, in addition to its primary receive (PRx) chain, a diversity receive (DRx) chain. The primary RFIC may be used to support a pair of PRx and DRx chains, and the core resource RFIC integrating with the PRx chain to provide multiple RF receive paths, and the DRx chain to provide diversity paths for those multiple RF receive paths.

Use of the disclosed core-resource RFIC with a primary RFIC may support multiple paths and provide for the reuse of certain shared RF resources with minimum modification, and provide a less problematic implementation to inserting additional RF resources into existing RFIC designs or utilizing two existing primary RFICs to support two RF paths.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

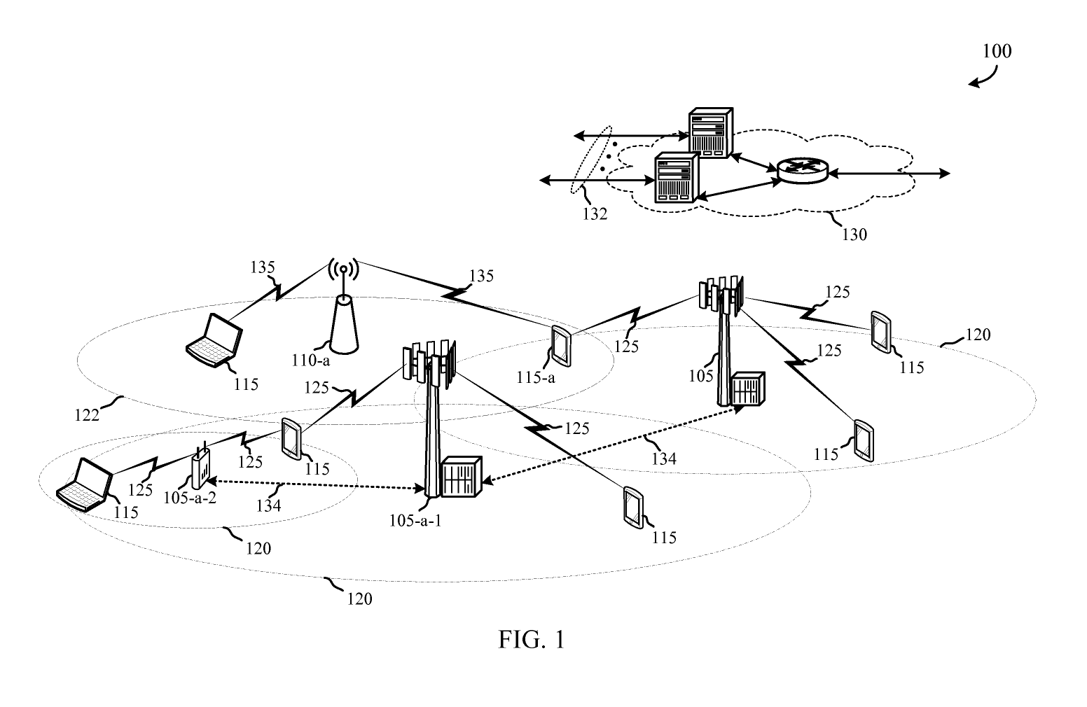

Referring first to FIG. 1, a system diagram illustrates an example of a wireless communications system 100. The wireless communications system 100 may include base station(s) 105, AP(s) 110, and mobile devices such as UEs 115. The AP 110 may provide wireless communications via a wireless local area network (WLAN) radio access network (RAN) such as, e.g., a network implementing at least one of the IEEE 802.11 family of standards. The AP 110 may provide, for example, WLAN or other short range (e.g., Bluetooth and Zigbee) communications access to a UE 115. Each AP 110 has a geographic coverage area 122 such that UEs 115 within that area can typically communicate with the AP 110. UEs 115 may be multi-access mobile devices that communicate with the AP 110 and a base station 105 via different radio access networks. The UEs 115, such as mobile stations, personal digital assistants (PDAs), other handheld devices, netbooks, notebook computers, tablet computers, laptops, display devices (e.g., TVs, computer monitors, etc.), printers, etc., may be stationary or mobile and traverse the geographic coverage areas 122 and/or 120, the geographic coverage area of a base station 105. While only one AP 110 is illustrated, the wireless communications system 100 may include multiple APs 110. Some or all of the UEs 115 may associate and communicate with an AP 110 via a communication link 135 and/or with a base station 105 via a communication link 125.

The wireless communications system 100 may also include a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

A UE 115 can be covered by more than one AP 110 and/or base station 105 and can therefore associate with multiple APs 110 or base stations 105 at different times. For example, a single AP 110 and an associated set of UEs 115 may be referred to as a basic service set (BSS). An extended service set (ESS) is a set of connected BSSs. A distribution system (DS) (not shown) is used to connect APs 110 in an extended service set. A geographic coverage area 122 for an AP 110 may be divided into sectors making up only a portion of the geographic coverage area (not shown). The wireless communications system 100 may include APs 110 of different types (e.g., metropolitan area, home network, etc.), with varying sizes of coverage areas and overlapping coverage areas for different technologies. Although not shown, other wireless devices can communicate with the AP 110.

The base stations 105 may wirelessly communicate with the UEs 115 via base station antennas. Each of the base station 105 sites may provide communication coverage for a respective geographic coverage area 120. In some examples, base stations 105 may be referred to as a base transceiver station, a radio base station, an AP, a radio transceiver, a NodeB, eNodeB (eNB), small cell, Home NodeB, a Home eNodeB, or some other suitable terminology. The geographic coverage area 120 for a base station 105 may be divided into sectors making up only a portion of the coverage area (not shown). The wireless communications system 100 may include base stations 105 of different types (e.g., macro and/or small cell base stations). There may be overlapping geographic coverage areas 120/122 for different technologies.

In some examples, the wireless communications system 100 includes portions of Long Term Evolution (LTE), LTE-Advanced (LTE-A) network, LTE for unlicensed spectrum (LTE-U), or licensed-assisted access for LTE (LTE-LAA). In LTE/LTE-A networks, the term evolved Node B (eNB) may be generally used to describe the base stations 105, while the term UE may be generally used to describe the UEs 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell, for example macro base station 105-a-1, generally covers a relatively large geographic area (e.g., several kilometers in radius) and may allow unrestricted access by UEs with service subscriptions with the network provider. A small cell, for example small cell base station 105-a-2, is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARM) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network supporting radio bearers for the user plane data. At the Physical (PHY) layer, the transport channels may be mapped to Physical channels.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations and network equipment including macro eNBs, small cell eNBs, relay base stations, APs, and the like.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include at least one carrier, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined. Similarly, communication links 135, also shown in wireless communications system 100, may include UL transmissions from a UE 115 to an AP 110, and/or DL transmissions from an AP 110 to a UE 115.

In some embodiments of the system 100, base stations 105, APs 110, and/or UEs 115 may include multiple antennas for employing antenna diversity schemes to improve communication quality and reliability between base stations 105, APs 110, and UEs 115. Additionally or alternatively, base stations 105, APs 110, and/or UEs 115 may employ multiple-input, multiple-output (MIMO) techniques that may take advantage of multi-path environments to transmit multiple spatial layers carrying the same or different coded data.

System 100 includes a UE 115-a which may be in communication with a base station 105 or an AP 110. As an example, UE 115-a may communicate with the AP 110 using Wi-Fi or other WLAN communications, or UE 115-a may communicate with the base stations 105 using LTE, GSM, or other wireless wide area network (WWAN) communications. As an example, the UE 115-a may utilize carrier aggregation or be a dual-radio, dual-SIM, dual-standby (DR-DSDS) device having a first SIM (SIM1) and a second SIM (SIM2).

The UE 115-a, AP 110-a, and/or small cell base station 105-a-2 may also include a receive chain having multiple RF receive paths to support a number of different downlink radios, each of which may be used by multiple wireless communications at different times. For example, a first wireless communication (such as an LTE communication) may utilize the receive chain during a first time period, and a second wireless communication (such as a GSM communication) may utilize the receive chain during a second time period. Despite having multiple different RF receive paths, certain of the RF resources of the receive chain may be shared between the multiple RF receive paths such that each of the RF receive paths of the receive chain use those resources. These RF resources represent bottleneck resources. Certain of the RF resources of the receive chain may be unique to a particular receive path, and may not be shared with other RF receive paths even when that RF receive path is otherwise not in use. These un-sharable RF resources represent unused RF resources during these time.

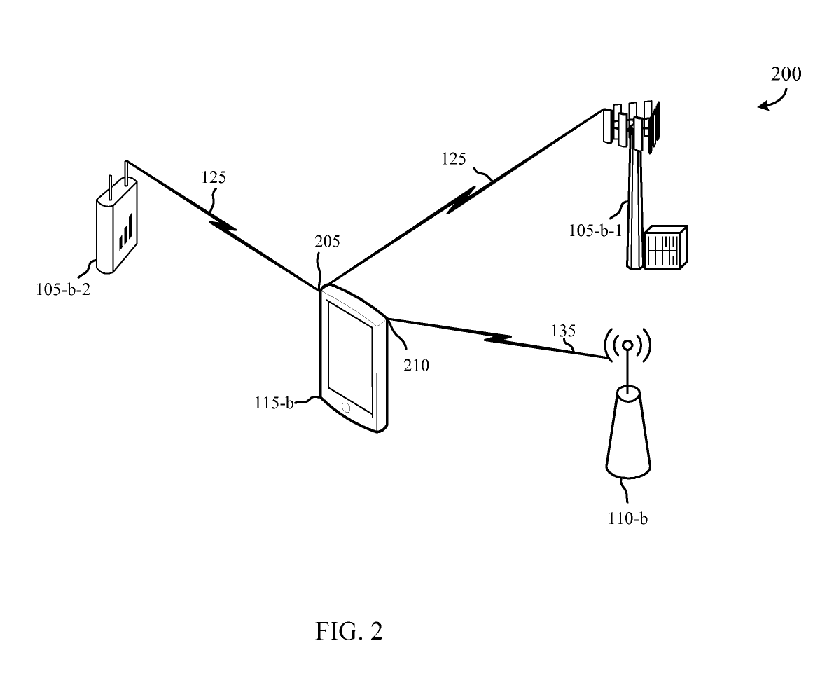

FIG. 2 illustrates a system diagram that shows an example of a wireless communications system 200. The wireless communications system 200 may include base stations 105-b-1 and 105-b-2, which may be for example a macro eNB and a small cell eNB, respectively, AP 110-b and UE 115-b. The UE 115-b may be an example of UE 115-a in system 100 of FIG. 1 and may be engaged in wireless communications, for example WWAN and/or WLAN communications, using antennas 205 and/or 210. The antennas 205-a may also include one or more diversity WWAN antennas for WWAN communications with base station 105-b-1 and/or base station 105-b-2, for example where the WWAN communication may support carrier aggregation (CA) or multi-carrier mode. The base stations 105-b-1 and 105-b-2 may be examples of base stations 105 included in system 100 of FIG. 1, and the AP 110-b may be an example of the AP 110 in system 100 of FIG. 1.

The UE 115-b may include a receiver including receive chains used to support a number of different downlink radios via different receive paths, for example to support different RF bands associated with received communications, which may be WWAN and/or WLAN communications, or other wireless communications.

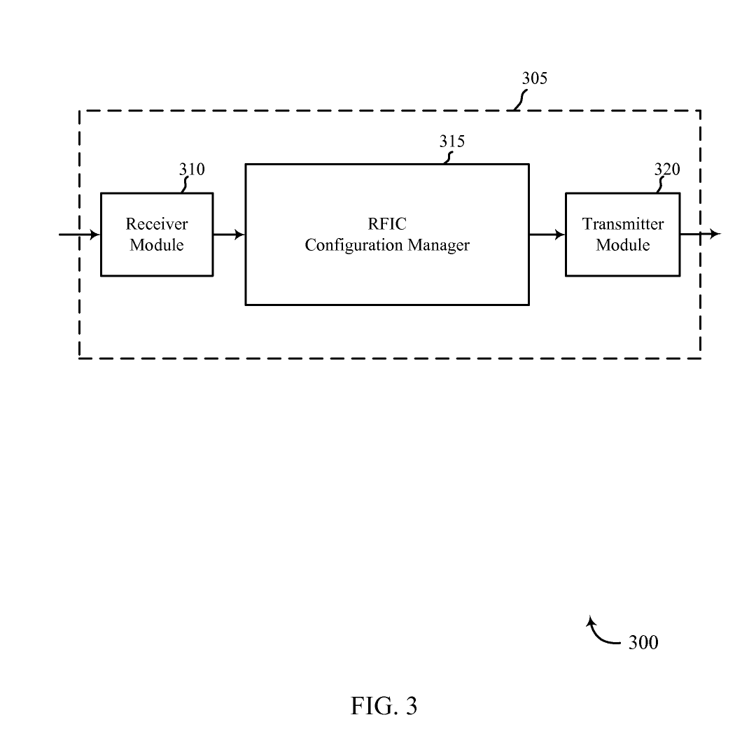

FIG. 3 shows a block diagram 300 of an apparatus 305 for use in a wireless device for wireless communication, in accordance with various aspects of the present disclosure. In some examples, the apparatus 305 may be an example of aspects of one or more of the UEs 115 described with reference to FIGS. 1 and/or 2. The apparatus 305 may also be or include a processor (not shown). The apparatus 305 may include a receiver module 310, an RFIC configuration manager 315, and/or a transmitter module 320. Each of these modules may be in communication with each other.

The apparatus 305, through the receiver module 310, the RFIC configuration manager 315, and/or the transmitter module 320, may be configured to perform functions described herein. For example, the apparatus 305 may be configured to manage the configuration of receiver module 310, including setting various switches to allocate RF resources of the receiver module 310 among and between different RF receive paths of at least a primary RFIC and a core resource RFIC that interfaces with the primary RFIC to enable additional functionality of the primary RFIC.

The components of the apparatus 305 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by one or more general or application-specific processors.

The receiver module 310 may receive information such as packets, user data, and/or control information associated with various information channels (e.g., control channels, data channels, etc.). The receiver module 310 may be configured to receive RF signals in a number of different frequency bands, which may represent different carriers in carrier aggregation or RF signals associated with two different subscriber identity modules (SIMs) in a dual-radio, dual-SIM, dual-standby (DR-DSDS) configuration. Information may be passed on to the RFIC configuration manager 315, and to other components of the apparatus 305.

The RFIC configuration manager 315 may be configured to manage the configuration of receiver module 310, including setting various switches to allocate RF resources of the receiver module 310 among and between different RF receive paths of at least a primary RFIC and a core resource RFIC that interfaces with the primary RFIC to enable additional functionality of the primary RFIC.

The transmitter module 320 may transmit the one or more signals received from other components of the apparatus 305. In some examples, the transmitter module 320 may be collocated with the receiver module 310 in a transceiver module. The transmitter module 320 may include a single antenna, or it may include a plurality of antennas.

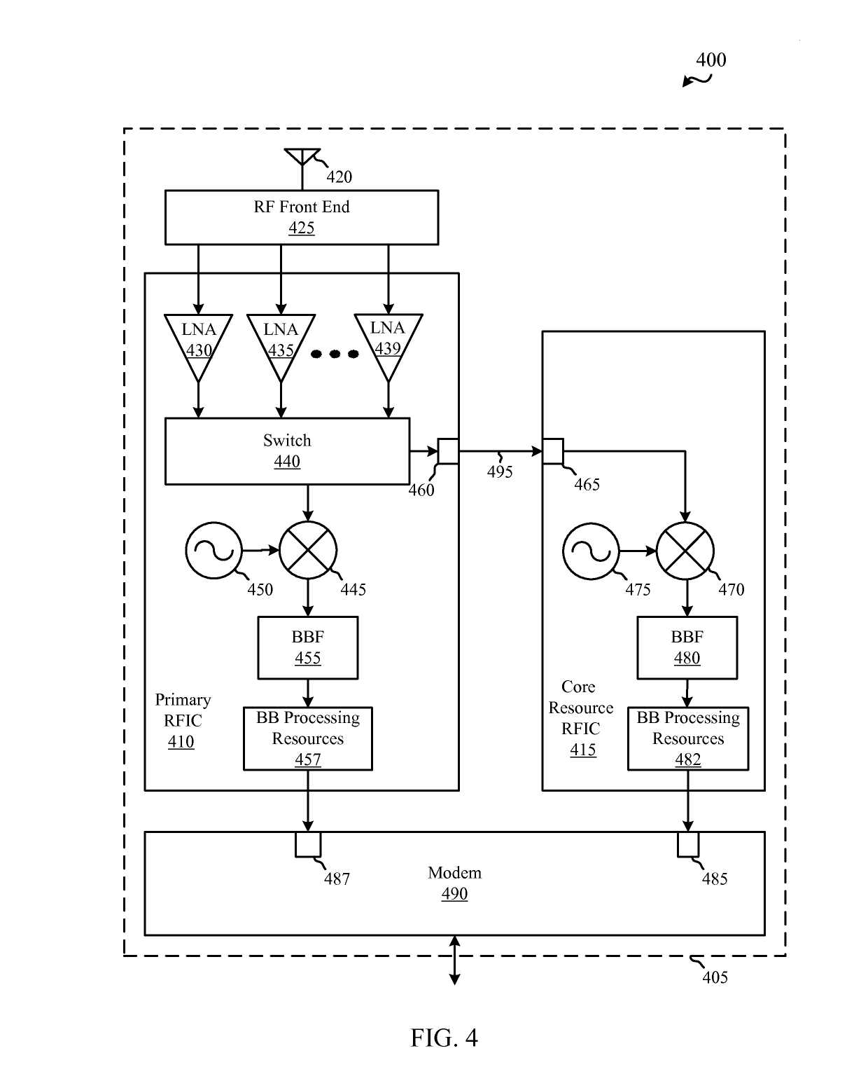

FIG. 4 shows a block diagram 400 of a receiver apparatus 405 for use in a wireless device for wireless communication, in accordance with various aspects of the present disclosure. In some examples, the receiver apparatus 405 may be an example of aspects of the receiver module 310 described with reference to FIG. 3.

The receiver apparatus 405 may include a primary RFIC 410, a core resource RFIC 415, and a modem 490. The receiver apparatus 405 may also include an antenna 420 to receive a plurality of signals, and an RF front end 425. One or more of primary RFIC 410, core resource RFIC 415, and modem 490 may be separately packaged, and also fabricated using a variety of different integrated circuits (IC) fabrication technologies, e.g. as a monolithic IC, hybrid IC, system-in-package, multi-chip module, etc.

The RF front end 425 receives a plurality of signals from the antenna 420. RF front end 425 may include switches to support multiple signal bands received by the antenna and to be received and processed by the UE 115. The switches of the RF front end 425 operate to change RF receive paths of the RF receive chain between antenna 420 and one or more of a number RF receive paths appropriate to the received RF signal. The RF front end 425 may contain a number of bandpass filters, where each bandpass filter may be configured to isolate a specific signal band to pass to a certain RF path, while rejecting signals outside of the pass band.

The primary RFIC 410 includes a bank of low-noise amplifiers (LNAs) LNA 430 through LNA 439 to support a number of signal bands, the bank of LNAs including at least LNA 430 and LNA 435. LNA 430 may support a certain signal bands, such that the RF front end 425 direct signals with a frequency in that band to LNA 430. LNA 435 may support a different signal band, such that the RF front end 425 direct signals with a frequency in this second band to LNA 435. LNA 430 may also be specifically configured or designed to amplify signals over a certain bandwidth, and LNA 435 may be specifically configured or designed to amplify signals over a different bandwidth. For example, where a receiver apparatus 405 is a part of a WWAN transceiver for LTE, LNA 430 may have a relatively high frequency bandwidth and LNA 435 may have a relatively low frequency bandwidth. The bandwidths may be adjacent or non-adjacent in the frequency domain. LNA 430 and LNA 435 may be one of a variety of LNAs, including IC LNAs, suitable for amplifying a particular bandwidth of RF signals.

Switch 440 of primary RFIC 410 may direct the amplified RF signals received from LNA 430 and LNA 435 to mixer 445 (synthesizer) or to a port 460 of inter RFIC interface 495. Switch 440 may be comprise multiple RF switches, including a matrix of RF switches. Switch 440 may be under the control of a configuration manager or other software and/or hardware component to configure receiver apparatus 405 to allocate RF resources according to the band of RF signals received by the receiver apparatus 405, and may direct the received RF signals to utilize further RF resources within the primary RFIC, or RF resources with the core resource RFIC.

On the first RF path, i.e. the RF path continuing through the primary RFIC, a mixer 445, or frequency mixer, may mix the input RF signal received from the switch 440 with a signal from mixer 445 to generate a downconverted I/Q signal. Mixer 445 may be a multiplicative mixer suitable to be fabricated as part of an IC.

Next in the RF receive path of the RF receive chain, the I/Q signal output from mixer 445 may be output to a baseband filter (BBF), which here is BBF 455. BBF 455 may be specific to a particular band supported by the RF receive path. BBF 455 may then pass the filtered signal to base band (BB) processing resources 457 of the primary RFIC for further processing. After processing by the BB processing resources 457, a signal may be output to a port 487 of modem 490 for additional baseband processing. Modem 490 may also be referred to herein as a digital baseband, baseband processor, baseband, etc. Modem 490 may provide processing support for multiple RF receive paths in addition to the first RF receive path. Although not further discussed herein, modem 490 may also perform baseband processing for outgoing RF paths, i.e. portions of modem 490 may be examples of aspects of the transmitter module 320 described with reference to FIG. 3.

A second RF path may be directed to the core resource RFIC by switch 440. The core resource RFIC contains those RF resources of the RF receive chain that are not shared by the first and second RF paths within the primary RFIC 410, i.e. the RF resources of the primary RFIC 410 that are bottleneck resources. In particular, core resource RFIC comprises RF resources including a mixer 470, oscillator 475, BBF 480, and BB processing resources 482 for the second RF path. These RF resources may also represent the minimum RF resources determined to be necessary to support the second RF path outside the primary RFIC and before the modem 490 handles additional baseband processing.

On the second RF path, i.e. the RF path to be directed to the core resource RFIC, switch 440 has directed an RF signal associated with the second RF path to a port 460 of an inter RFIC interface 495. The inter RFIC interface 495 may be use existing interface of the RFIC that has the capability to provide RF signals to the outside of the primary RFIC 410. For example, the primary RFIC 410 may have an existing RF interface for testing, or other development purposes. A port 465 of the core resource RFIC 415 may be configured to receive an input from the inter RFIC interface 495. Thus the amplified RF output of one of LNA 430 or LNA 435 may be received by mixer 470. Mixer 470 may mix the input RF signal received from the switch 440 as part of the second RF path with a signal from oscillator 475 to generate a downconverted I/Q signal that is sent to modem 490 for baseband processing. Modem 490 may provide processing support for multiple RF receive paths in addition to the first and second RF receive paths.

Although a primary receive (PRx) chain may be illustrated for receiver apparatus 405, receiver apparatus 405 may also support a diversity receive (DRx) chain that is not illustrated for clarity. Data may be received at a mobile device using a receive chain that uses the primary antenna, and a second receive chain, commonly referred to as a diversity receive chain, that uses a secondary antenna. The use of multiple receive chains may be effective in enhancing user experience through higher data transmission rates. The DRx chain may be substantially a duplicate of the PRx chain. Both the primary RFIC 410 and core resource RFIC 415 may have duplicate DRx chains. Thus, primary RFIC 410 may have a second antenna, second RF front end, second set of LNAs, second switch, second mixer, second oscillator, second BBF, and second BB processing resources dedicated to the separate DRx chain that is substantially a mirror. Similarly, the core resource RFIC 415 may have a second mixer, second oscillator, second BBF, and second BB processing resources dedicated to the separate DRx chain. Modem 490 may also have additional ports to receive the I/Q signals output from the primary RFIC 410 and core resource RFIC 415 in connection with the DRx chains.

Furthermore, while FIG. 4 illustrates two LNAs to support two RF bands, primary RFIC 410 may support many more bands, and thus many different RF receive paths. Thus, additional LNAs may be added, and RF front end 425 and switch 440 configured to support additional the additional RF paths. Similarly, oscillator 450, mixer 445, BBF 455, BB processing resources 457, oscillator 475, mixer 470, BBF 480, and/or BB processing resources 482 may be configured to support bands across a wider bandwidth.

In addition, while a single one of core resource RFIC 415 is illustrated, a second, or additional, core resource ICs may be added to provide standalone RF resources for a third, or additional, RF receive paths that are not being used in the primary RFIC to enable further additional functionality.

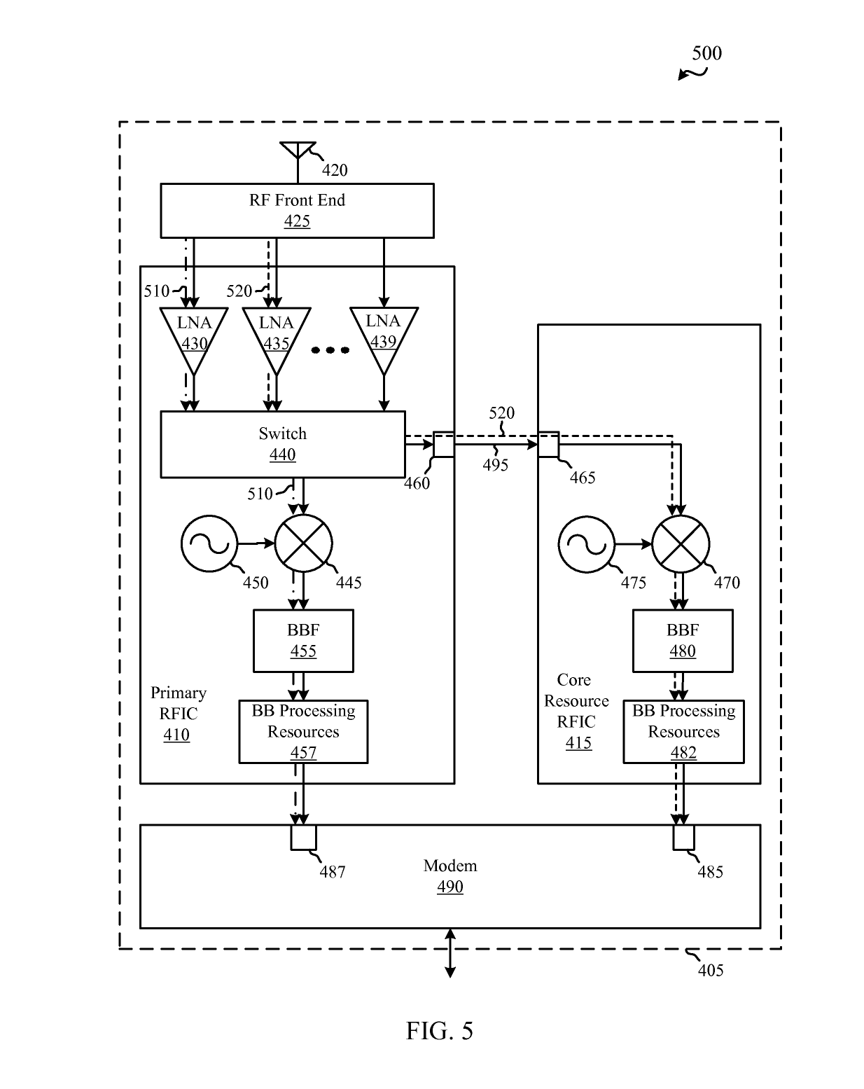

FIG. 5 shows a block diagram 500 of the receiver apparatus 405 for use in a wireless device for wireless communication, annotated to illustrate two RF receive paths in accordance with various aspects of the present disclosure. Block diagram 500 may illustrate a case where two sets of RF signals are received within two different bands. For example, the received RF signals may represent inter-band carrier aggregation RF signals, i.e. carriers in a carrier aggregation scenario that are in different bands. As another example, the received RF signals may be for two different SIMs in a DR-DSDS scenario, where the RF signals for the first SIM fall into a first band, while the RF signals for the second SIM fall into a second band.

In this first case, RF receive path 510, illustrated by a dash-dot line, supports a first RF signal received in a first band, and is switched by RF front end 425 through LNA 430, switch 440, mixer 445, BBF 455, and BB processing resources 457 of primary RFIC 410, which outputs the processed RF signal as a first I/Q signal to modem 490. In the absence of the core resource RFIC 415, redundant RF resources of different RF receive paths may not be used even though they exist to support multiple different bands.

RF receive path 520, illustrate by a dash line, supports a second RF signal that falls into a different band than the first RF signal. The RF receive path 520 is also switched by RF front end 425, which already exists to support multiple different bands. However, because the second RF signal associated is in a different band than the first RF signal, it is supported by a second LNA, LNA 430. LNA 430 may be specific to the band associated with second RF signal. Switch 440 then directs the second RF signal via the RF receive path 520 toward the core resource RFIC 415 via the inter RFIC interface 495. The second RF path then passes mixer 470, BBF 480, and BB processing resources 482 of core resource RFIC 415, which outputs the processed RF signal as a second I/Q signal to modem 490. Modem 490 may already have the resources to baseband process RF signals received on two RF paths because modem 490 may be configured to support multiple different bands that may be receive via the receive chain.

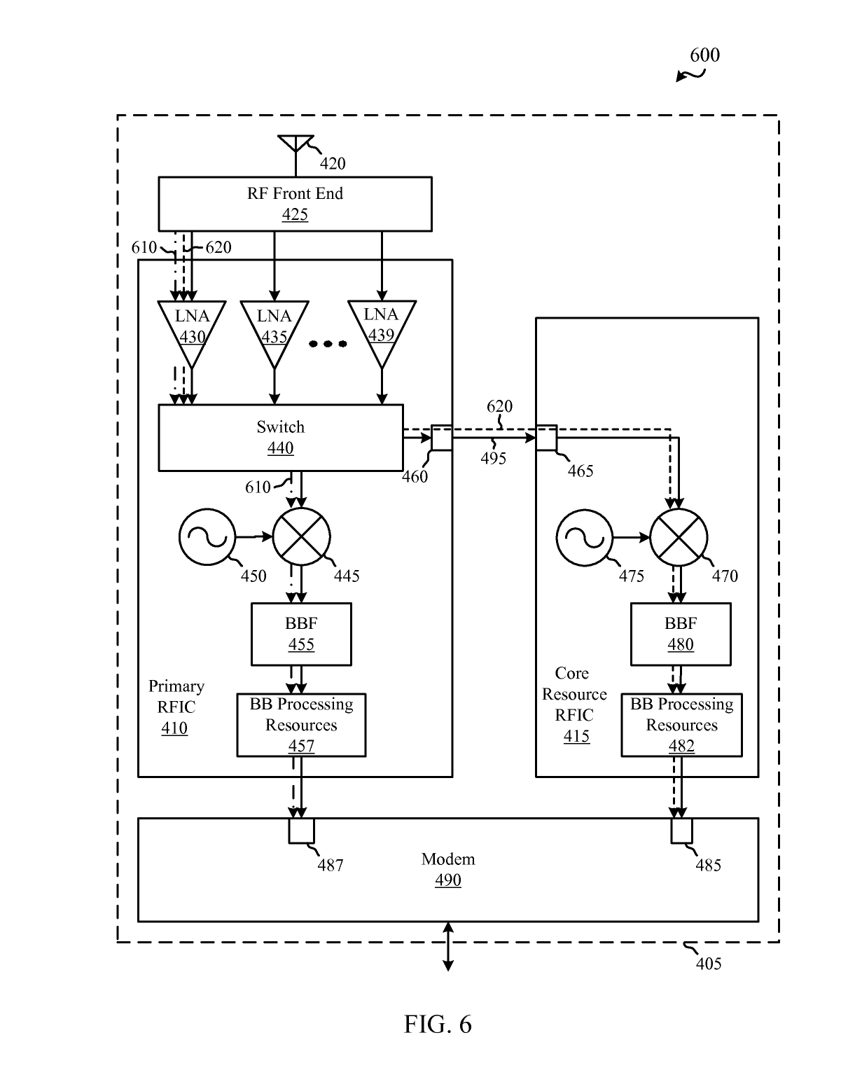

FIG. 6 shows a second block diagram 600 of the receiver apparatus 405 for use in a wireless device for wireless communication, annotated to illustrate two RF receive paths in accordance with various aspects of the present disclosure. Second block diagram 600 may illustrate a case where two sets of RF signals are received within a single supported bands. For example, the received RF signals may represent intra-band, non-contiguous carrier aggregation RF signals, i.e. carriers in a carrier aggregation scenario that are in the same band but not contiguous with each other. As another example, the received RF signals may be for two different SIMs in a DR-DSDS scenario, where the RF signals for the SIMs fall into the same band.

In this second case, RF receive path 610, illustrated by a dash-dot line, supports a first RF signal received in a first band, and is switched by RF front end 425 through LNA 430, switch 440, mixer 445, BBF 455, and BB processing resources 457 of primary RFIC 410, which outputs the processed RF signal as a first I/Q signal to modem 490.

RF receive path 620, illustrate by a dash line, supports a second RF signal that falls in the same band as the first RF signal, but is non-contiguous with the first RF signal's band. Like RF receive path 610, RF receive path 620 is also switched by RF front end 425 to LNA 430 because LNA 430 supports the same band into which both RF signals fall. Switch 440 then directs the second RF signal via the RF receive path 620 toward the core resource RFIC 415 via the inter RFIC interface 495. The second RF path then passes mixer 470, BBF 480, and BB processing resources 482 of core resource RFIC 415, which outputs the processed RF signal as a second I/Q signal to modem 490. As noted above, modem 490 may already have the resources to baseband process RF signals received on two RF paths because modem 490 may be configured to support multiple different bands that may be receive via the receive chain.

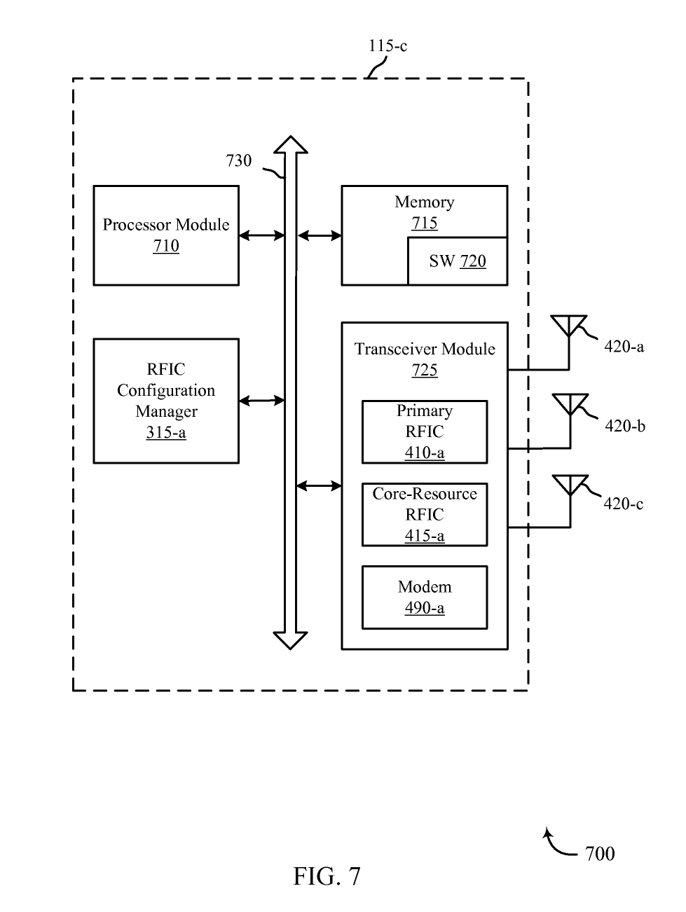

FIG. 7 shows a system 700 for use in wireless communication, in accordance with various examples. System 700 may include a UE 115-c, which may be an example of the UEs 115 of FIGS. 1 and/or 2. UE 115-c may also be an example of one or more aspects of apparatus 305 of FIG. 3.

The UE 115-c may generally include components for bi-directional voice and data communications including components for transmitting communications and components for receiving communications. The UE 115-c may include antenna(s) 420, a transceiver module 725, a processor module 710, and memory 715 (including software (SW) 720), which each may communicate, directly or indirectly, with each other (e.g., via one or more buses 730). Antenna(s) 420 may be, for example one or more of a primary antenna, a diversity antenna, and a WLAN antenna. The transceiver module 725 may be configured to communicate bi-directionally, via the antenna(s) 420 and/or one or more wired or wireless links, with one or more networks, as described above. For example, the transceiver module 725 may be configured to communicate bi-directionally with base stations 105 and/or APs 110 with reference to FIGS. 1 and/or 2. The transceiver module 725 may include a modem 490-a configured to modulate the packets and provide the modulated packets to the antenna(s) 420 for transmission, and to demodulate packets received from the antenna(s) 420. The transceiver module may include a primary RFIC 410-a to support a plurality of RF paths, including a plurality of RF receive paths and a plurality of diversity RF receive paths. Primary RFIC 410-a may also be an example of one or more aspects of primary RFIC 410 of FIGS. 4-6. The transceiver module may also include a core resource RFIC 415-a configured that integrates with primary RFIC 410-a to enable additional receive functionality of the plurality of RF paths of the primary RFIC. Core resource RFIC 415-a may also be an example of one or more aspects of core resource RFIC 415 of FIGS. 4-6.

While the UE 115-a may include a single of antenna 420, the UE 115-a may have multiple of antenna 420 capable of concurrently transmitting and/or receiving multiple wireless transmissions. The transceiver module 725 may be capable of concurrently communicating with one or more base stations 105 via multiple component carriers.

The UE 115-c may include a RFIC configuration manager 315-a, which may perform the functions described above for the RFIC configuration manager 315 of apparatus 305 of FIG. 3. The RFIC configuration manager 315-c may manage the configuration of receiver apparatus 405, including setting various switches, for example of RF front end 425 and/or switch 440 FIGS. 4-6 to allocate RF resources of receiver apparatus 405 among and between different RF receive paths of primary RFIC 410, core resource RFIC 415, and/or modem 490 of FIGS. 4-6 or primary RFIC 410-a, core resource RFIC 415-a, and/or modem 490-a, to enable additional functionality of the primary RFIC by integrating the core resource RFIC with the primary RFIC.

The memory 715 may include random access memory (RAM) and read-only memory (ROM). The memory 715 may store computer-readable, computer-executable software/firmware code 720 containing instructions that are configured to, when executed, cause the processor module 710 to perform various functions described herein (e.g., integrating the standalone RF resources of a core resource RFIC 415-a to integrate with the plurality of RF receive paths of the primary RFIC 410-a to enable an additional functionality of the primary RFIC, determining the minimum RF resources necessary to support additional RF receive paths, and operating the modem 490-a to support multiple RF paths from both the primary and core resource RFICs, switching the RF paths to integrate the core resource RFIC with the primary RFIC, etc.). Alternatively, the computer-readable, computer-executable software/firmware code 720 may not be directly executable by the processor module 710 but be configured to cause a computer (e.g., when compiled and executed) to perform functions described herein. The processor module 710 may include an intelligent hardware device, e.g., a central processing unit (CPU), a microcontroller, an application-specific integrated circuit (ASIC), etc.

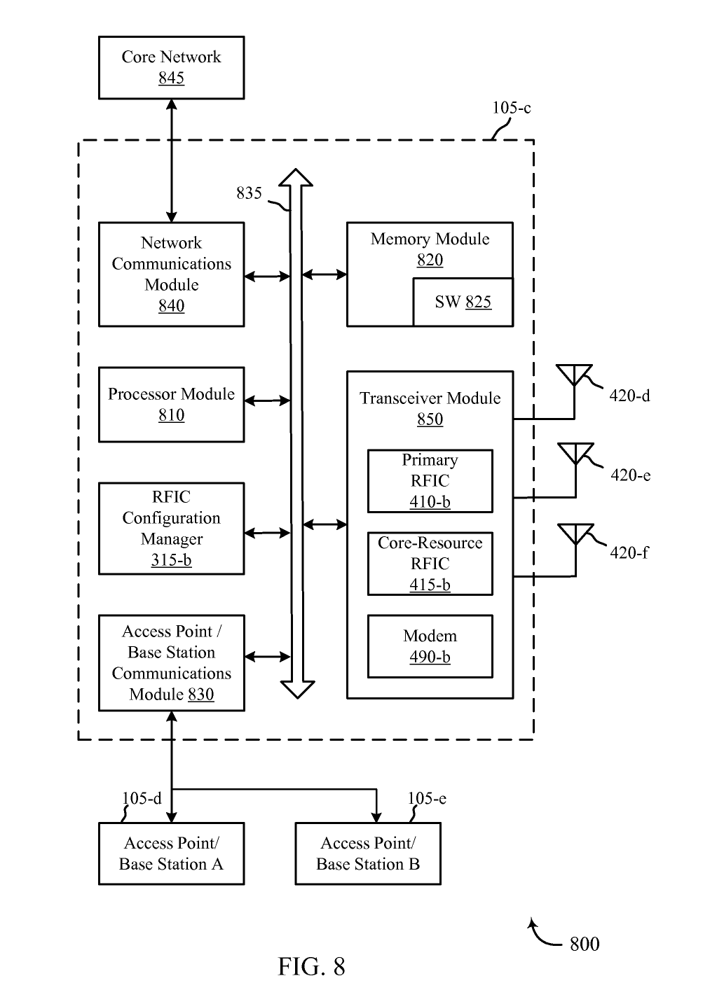

FIG. 8 shows a block diagram 800 of a base station 105-c (e.g., an access point or a base station forming part or all of a small cell eNB) for use in wireless communication, in accordance with various aspects of the present disclosure. In some examples, the base station 105-c may be an example of aspects of one or more of the base stations 105 described with reference to FIGS. 1-2, aspects of one or more of the APs 110 described with reference to FIGS. 1-2, and/or aspects of one or more of the apparatus 305 and/or receiver apparatus 405 when configured as or as part of a base station or an access point, as described with reference to FIGS. 3-6. The base station may be a small cell, such as a micro cell, femto cell, or pico cell, for example small cell base station 105-a-2 of FIG. 1 and/or small cell base station 105-b-2 of FIG. 2. The base station 105-c may be configured to implement or facilitate at least some of the base station, access point, and/or apparatus features and functions described with reference to FIGS. 1-3.

The base station 105-c may include a processor module 810, a memory module 820, at least one transceiver module (represented by transceiver module 850, at least antennas 420-d, 420-e, and 420-f, and/or a RFIC configuration manager 315-b. The base station 105-c may also include one or more of an access point/base station communications module 830 and/or a network communications module 840. Each of these modules may be in communication with each other, directly or indirectly, over one or more buses 835.

The memory module 820 may include random access memory (RAM) and/or read-only memory (ROM). The memory module 820 may store computer-readable, computer-executable software/firmware code 825 containing instructions that are configured to, when executed, cause the processor module 810 to perform various functions described herein related to wireless communication (e.g., integrating the standalone RF resources of a core resource RFIC 415-b to integrate with the plurality of RF receive paths of the primary RFIC 410-b to enable an additional functionality of the primary RFIC, determining the minimum RF resources necessary to support additional RF receive paths, and operating the modem 490-b to support multiple RF paths from both the primary and core resource RFICs, switching the RF paths to integrate the core resource RFIC with the primary RFIC, etc.). Alternatively, the computer-readable, computer-executable software/firmware code 825 may not be directly executable by the processor module 810 but be configured to cause the base station 105-c (e.g., when compiled and executed) to perform various of the functions described herein.

The processor module 810 may include an intelligent hardware device, e.g., a central processing unit (CPU), a microcontroller, an ASIC, etc. The processor module 810 may process information received through the transceiver module 850, the access point/base station communications module 830, and/or the network communications module 840. The processor module 810 may also process information to be sent to the transceiver module 850 for transmission through the antennas 420-d, 420-e, and/or 420-f, to the access point/base station communications module 830, for transmission to one or more other access point/base stations, for example base stations 105-d and 105-e, and/or to the network communications module 840 for transmission to a core network 845, which may be an example of one or more aspects of the core network 130 described with reference to FIG. 1. The processor module 810 may handle, alone or in connection with the RFIC configuration manager 315-b, various aspects of integrating the standalone RF resources of a core resource RFIC 415-b to integrate with the plurality of RF receive paths of the primary RFIC 410-b to enable an additional functionality of the primary RFIC, determining the minimum RF resources necessary to support additional RF receive paths, and operating the modem 490-b to support multiple RF paths from both the primary and core resource RFICs, switching the RF paths to integrate the core resource RFIC with the primary RFIC.

The transceiver module 850 may include a modem configured to modulate packets and provide the modulated packets to the antennas 420-d, 420-e, and/or 420-f for transmission, and to demodulate packets received from the antennas. The transceiver module 850 may, in some examples, be implemented as one or more transmitter modules and one or more separate receiver modules. The transceiver module 850 may support communications in a first radio frequency spectrum band and/or a second radio frequency spectrum band. The transceiver module 850 may be configured to communicate bi-directionally, via the antennas 420-d, 420-e, and/or 420-f, with one or more UEs or apparatuses, such as one or more of the UEs 115 described with reference to FIGS. 1 and/or 2. The base station 105-c may, for example, include multiple base station antennas (e.g., an antenna array). The base station 105-c may communicate with the core network 845 through the network communications module 840. The base station 105-c may also communicate with other base stations and/or access points, such as base stations 105-d and 105-e, using the access point/base station communications module 830.

The base station 105-c may include a RFIC configuration manager 315-b, which may perform the functions described above for the RFIC configuration manager 315 of apparatus 305 of FIG. 3 and/or UE 115-c of FIG. 7. The RFIC configuration manager 315-b may manage the configuration of receiver apparatus 405, including setting various switches, for example of RF front end 425 and/or switch 440 of FIGS. 4-6 to allocate RF resources of receiver apparatus 405 among and between different RF receive paths of primary RFIC 410, core resource RFIC 415, and/or modem 490 of FIGS. 4-6 or primary RFIC 410-b, core resource RFIC 415-b, and/or modem 490-b, to enable additional functionality of the primary RFIC by integrating the core resource RFIC with the primary RFIC.

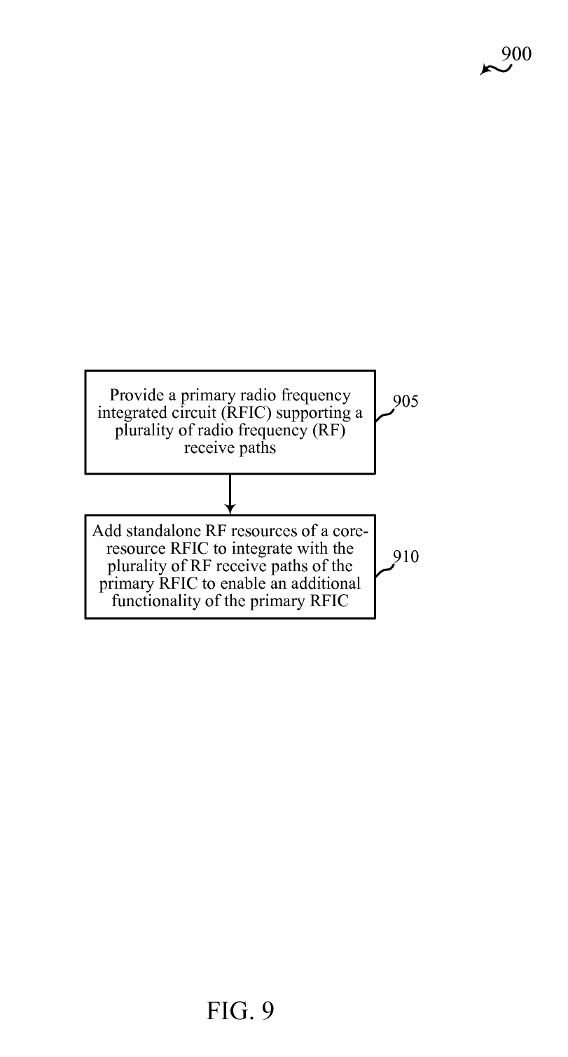

FIG. 9 is a flow chart illustrating a first example of a method 900 for wireless communication, in accordance with various aspects of the present disclosure. For clarity, the method 900 is described below with reference to aspects of one or more of the wireless devices described with reference to FIGS. 1-8. In some examples, a wireless device may execute one or more sets of codes to control the functional elements of the wireless device to perform the functions described below. Additionally or alternatively, the wireless device may perform one or more of the functions described below using-purpose hardware.

At block 905, the method 900 may include providing a primary RFIC supporting a plurality of RF receive paths. The operation(s) at block 905 may be performed using the RFIC configuration manager 315 described with reference to FIGS. 3, 7, and/or 8, and/or primary RFIC 410 described with reference to FIGS. 4-8.

At block 910, the method 900 may include adding standalone RF resources of a core-resource RFIC to integrate with the plurality of RF receive paths of the primary RFIC to enable an additional functionality of the primary RFIC. The operation(s) at block 905 may be performed using the RFIC configuration manager 315 described with reference to FIGS. 3, 7, and/or 8, and/or core resource RFIC 415 described with reference to FIGS. 4-8.

Thus, the method 900 may provide for wireless communication. It should be noted that the method 900 is just one implementation and that the operations of the method 900 may be rearranged or otherwise modified such that other implementations are possible.

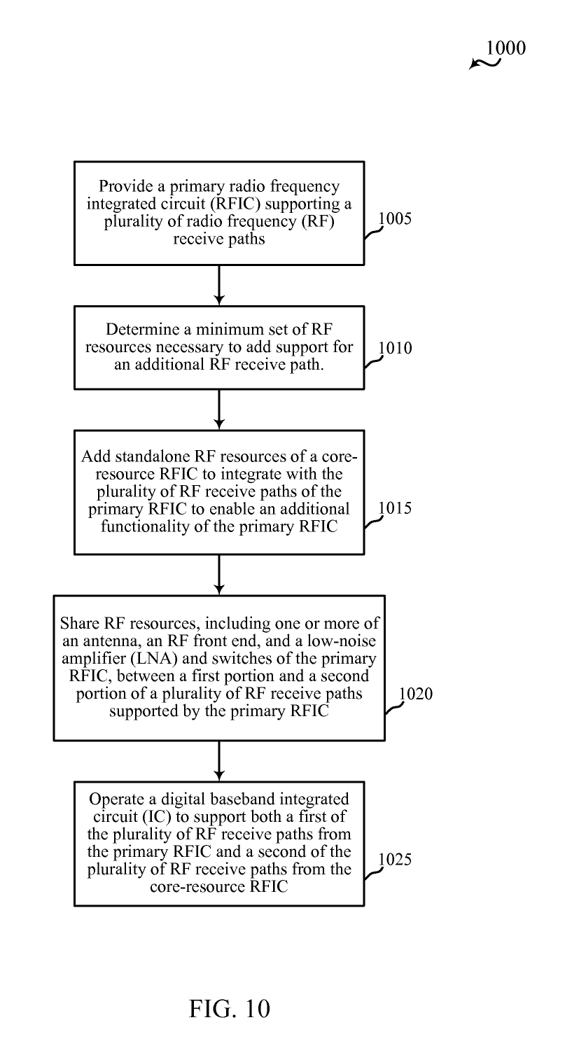

FIG. 10 is a flow chart illustrating a second example of a method 1000 for wireless communication, in accordance with various aspects of the present disclosure. For clarity, the method 1000 is described below with reference to aspects of one or more of the wireless devices described with reference to FIGS. 1-8. In some examples, a wireless device may execute one or more sets of codes to control the functional elements of the wireless device to perform the functions described below. Additionally or alternatively, the wireless device may perform one or more of the functions described below using-purpose hardware.

At block 1005, the method 1000 may include providing a primary RFIC supporting a plurality of RF receive paths. The operation(s) at block 1005 may be performed using the RFIC configuration manager 315 described with reference to FIGS. 3, 7, and/or 8, and/or primary RFIC 410 described with reference to FIGS. 4-8.

At block 1010, the method 1000 may include determining a minimum set of RF resources necessary to add support for an additional RF receive path. The operation(s) at block 1005 may be performed using the RFIC configuration manager 315 described with reference to FIGS. 3, 7 and/or 8.

At block 1015, the method 1000 may include adding standalone RF resources of a core-resource RFIC to integrate with the plurality of RF receive paths of the primary RFIC to enable an additional functionality of the primary RFIC. The operation(s) at block 1005 may be performed using the RFIC configuration manager 315 described with reference to FIGS. 3, 7, and/or 8, and/or core resource RFIC 415 described with reference to FIGS. 4-8.

At block 1020, the method 1000 may include sharing RF resources, including one or more of an antenna, an RF front end, and a low-noise amplifier (LNA) and switches of the primary RFIC, between a first portion and a second portion of a plurality of RF receive paths supported by the primary RFIC. The operation(s) at block 1005 may be performed using the RFIC configuration manager 315 described with reference to FIGS. 3, 7, and/or 8, and/or antenna 420, RF front end 425, and primary RFIC 410 described with reference to FIGS. 4-8.

At block 1025, the method 1000 may include operating a digital baseband integrated circuit (IC) to support both a first of the plurality of RF receive paths from the primary RFIC and a second of the plurality of RF receive paths from the core-resource RFIC. The operation(s) at block 1005 may be performed using the RFIC configuration manager 315 described with reference to FIGS. 3, 7, and/or 8, and/or modem 490 described with reference to FIGS. 4-8.

Thus, the method 1000 may provide for wireless communication. It should be noted that the method 1000 is just one implementation and that the operations of the method 1000 may be rearranged or otherwise modified such that other implementations are possible.

In some examples, aspects from two or more of the method 900 and method 1000 may be combined. It should be noted that the method 900 and method 1000 are just example implementations, and that the operations of the method 900 and method 1000 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
providing a primary radio frequency integrated circuit (RFIC) supporting a plurality of radio frequency (RF) receive paths; and
adding standalone RF resources of a core-resource RFIC to integrate with the plurality of RF receive paths of the primary RFIC to enable an additional functionality of the primary RFIC.

2. The method of claim 1, further comprising:
determining a minimum set of RF resources necessary to add support for an additional RF receive path.

3. The method of claim 1, wherein the additional functionality comprises support for an additional number of downlink radios to operate concurrently.

4. The method of claim 1, further comprising:
sharing RF resources of the primary RFIC between a first portion of a first of the plurality of RF receive paths supported by the primary RFIC and a first portion of a second of the plurality of RF receive paths supported by the primary RFIC and the core-resource RFIC.

5. The method of claim 1, further comprising:
operating a digital baseband integrated circuit (IC) to support both a first of the plurality of RF receive paths from the primary RFIC and a second of the plurality of RF receive paths from the core-resource RFIC.

6. The method of claim 1, wherein the added standalone RF resources of the core-resource RFIC comprise at least a mixer.

7. The method of claim 1, wherein the added standalone RF resources of the core-resource RFIC comprise at least a base band filter.

8. The method of claim 1, wherein:
the primary RFIC comprises at least a first mixer and a first base-band filter for a first of the plurality of RF receive paths of the primary RFIC; and
the standalone RF resources comprise at least a second mixer and a second base-band filter for a second of the plurality of RF receive paths from the primary RFIC.

9. The method of claim 1, wherein the core-resource RFIC comprises an RF interface to receive RF signals from the primary RFIC.

10. The method of claim 1, further comprising:
using a low-noise amplifier of the primary RFIC for a first RF receive path of the plurality of RF receive paths; and
using the standalone RF resources of the core-resource RFIC for the first RF receive path from the primary RFIC.

11. The method of claim 1, further comprising:
sharing a low-noise amplifier of the primary RFIC between both a first RF receive path of the plurality of RF receive paths and a second RF receive path of the plurality of RF receive paths.

12. The method of claim 1, further comprising:
sharing an antenna and a RF front end between a first RF path of the plurality of RF receive paths of the primary RFIC and a second RF path of the plurality of RF receive paths that uses the standalone RF resources of the core-resource RFIC.

13. An apparatus for wireless communication, comprising:
a primary radio frequency integrated circuit (RFIC) supporting a plurality of radio frequency (RF) receive paths;
means for adding standalone RF resources of a core-resource RFIC to integrate with the plurality of RF receive paths of the primary RFIC to enable an additional functionality of the primary RFIC.

14. The apparatus of claim 13, further comprising:
means for determining a minimum set of RF resources necessary to add support for an additional RF receive path.

15. The apparatus of claim 13, further comprising:
means for sharing RF resources of the primary RFIC between a first portion of a first of the plurality of RF receive paths supported by the primary RFIC and a first portion of a second of the plurality of RF receive paths supported by the primary RFIC and the core-resource RFIC.

16. An apparatus for wireless communication, comprising:
a primary radio frequency integrated circuit (RFIC) supporting a plurality of radio frequency (RF) receive paths; and
a core-resource RFIC comprising standalone RF resources to integrate with the plurality of RF receive paths of the primary RFIC to enable an additional functionality of the primary RFIC.

17. The apparatus of claim 16, wherein the plurality of standalone RF resources represent a minimum set of RF resources necessary to add support for an additional RF receive path.

18. The apparatus of claim 16, wherein the additional functionality comprises support for an additional number of downlink radios to operate concurrently.

19. The apparatus of claim 16, further comprising:
a first RF receive path of the plurality of RF receive paths supported by the primary RFIC; and
a second RF receive path of the plurality of RF receive paths supported by the primary RFIC and the core-resource RFIC,
wherein a first portion of the first RF receive path within the primary RFIC is shared with the second RF receive path within the primary RFIC.

20. The apparatus of claim 16, wherein:
the plurality of RF receive paths of the primary RFIC comprise primary RF receive paths and diversity RF paths; and
the plurality of standalone RF resources of the core-resource RFIC comprise primary standalone RF resources to integrate with one or more of the primary RF receive paths of the primary RFIC, and diversity standalone RF resources to integrate with one or more of the diversity RF receive paths of the primary RFIC.

21. The apparatus of claim 16, further comprising:
a digital baseband integrated circuit (IC) to process a plurality of signals from a first of the plurality of RF receive paths supported by the primary RFIC, and a plurality of signals from a second of the plurality of RF receive paths supported by both the primary RFIC and the core-resource RFIC.

22. The apparatus of claim 16, wherein the standalone RF resources of the core-resource RFIC comprise at least a mixer.

23. The apparatus of claim 16, wherein the standalone RF resources of the core-resource RFIC comprise at least a base band filter.

24. The apparatus of claim 16, wherein
the primary RFIC comprises at least a first mixer and a first base-band filter for a first of the plurality of RF receive paths of the primary RFIC; and
the standalone RF resources comprise at least a second mixer and a second base-band filter for a second of the plurality of RF receive paths from the primary RFIC.

25. The apparatus of claim 16, wherein the core-resource RFIC comprises an RF interface to receive RF signals from the primary RFIC.

26. The apparatus of claim 16, wherein:
the primary RFIC comprises a low-noise amplifier shared by both a first of the plurality of RF receive paths supported by the primary RFIC and a second of the plurality of RF receive paths supported by the primary RFIC and the core-resource RFIC.

27. The apparatus of claim 16, further comprising:
an antenna; and
a RF front end,
wherein the antenna and the RF front end are shared between a first of the plurality of RF receive paths supported by the primary RFIC and a second of the plurality of RF receive paths supported by the primary RFIC and the core-resource RFIC.

28. A non-transitory computer-readable medium storing computer-executable code for wireless communication, the code executable by a processor to:
add radio frequency (RF) resources of a core-resource radio frequency integrated circuit (RFIC) to integrate with a plurality of RF receive paths of a primary RFIC to enable an additional functionality of the primary RFIC.

29. The non-transitory computer-readable medium of claim 28, wherein the instructions are further executable by the processor to:
determine a minimum set of RF resources necessary to add support for an additional RF receive path.

30. The non-transitory computer-readable medium of claim 28, wherein the instructions are further executable by the processor to:
share RF resources of the primary RFIC between a first portion of a first of the plurality of RF receive paths supported by the primary RFIC and a first portion of a second of the plurality of RF receive paths supported by the primary RFIC and the core-resource RFIC.
